(19) United States
(12) Patent Application Publication
(10) Pub. No.: US 2011/0266117 A1
(43) Pub. Date: Nov. 3, 2011

(54) LOCKING DEVICE ON THE MOTOR SWITCH

(76) Inventor: Hsin-Yu CHEN, Xin-Bei City (TW)

(21) Appl. No.: 13/096,531

(22) Filed: Apr. 28, 2011

(30) Foreign Application Priority Data
Apr. 30, 2010 (TW) 099207924

(51) Int. Cl. H01H 9/28; E05B 65/00

(52) U.S. Cl. 200/43.11; 70/174

(57) ABSTRACT

A locking device comprising a safety lock switch unit for adjacently located the motor switch. The safety lock switch unit has a lock part and a piece of the action element therewith a control end extended to the motor switch. The locking device can control the handle of the motor switch cannot move.

### BACKGROUND OF THE INVENTION

(a) Field of the Invention

This invention is related to a locking device on the motor switch, especially for a multi-locking device which limits the motor power switch.

(b) Description of the Prior Art

Many electrical accidents have occurred in the event of electrical machinery maintenance, cause of the accident was not because of the sudden damage of the motor switch during maintenance, but due to administrative oversight or control operating improperly. Because the use of electrical power equipment maintenance, an often misunderstanding for workers is: mistaken mechanical electrical safety in the interdiction of emergency power button to completely cut off all power. However, in fact, emergency power-off button on the machine just cut off the power supply of the circuit of the relay, and did not really cut off the main power supply, but almost most people are mistakenly thought to cut off the main power supply.

This wrong perception, resulting in the maintenance of other third party without the knowledge of the event have been to see the motor switch, for example, the Non-Fuse Breaker, referred to as the NFB; or Molded Case Circuit Breaker, called MCCB for short, etc., or leakage circuit breakers in a trip is not the normal position, also found that electrical equipment off the operation, would be mistaken because the current pulse caused by lightning or a trip. Then kindly press the test and reset button to start the trip units and flip the handle of a fuse switch or residual current circuit breaker to restart the electrical equipment so that the machinery maintenance personnel in time to dodge the tragic accident.

And when an accident occurs, whether it is public safety units, maintenance units, field construction units, or production units will shirk the responsibility to each other, so boundaries and responsibilities are still not sufficient to achieve the lessons of the role of vigilance. In particular, the present invention is not attributable to the motor switch, in other words, the present invention is an independent body, as long as the traditional combination of or adjacent to the installation of various types of motor switch, the present invention can be by way of management and control of multiple motor control switch the main power supply.

### SUMMARY OF THE INVENTION

The main purpose of the present invention, in providing a locking device for adjacently located the motor switch each other, which can limit the trip does not move and keep the power switch (CB) or the escape test unit cannot act, so the maintenance can prevent other people mistakenly to start the motor switch.

Another purpose of the present invention, in providing a multi-locking device for adjacently located the motor switch each other, which also can multi-limit the trip does not move and keep the power switch or the escape test unit cannot act.

The purpose of the present invention one, in addition to the foregoing purposes, and further to provide a display unit for shows the locking device lock or not.

A further purpose of the present invention, in addition to the foregoing purposes, and further to provide a remote-controlled mechanism, when locking devices lock, can turn on or cut off the end of the loop signal, so that the remote control console can be displayed.

To achieve the above purpose, a locking device of the present invention comprising a safety lock switch unit for adjacently located the motor switch. The safety lock switch unit has at least one lock part, and a piece of the action element therewith a control end extended to the motor switch. The lock part can be move linked to the action element to control the trip inside the locked unit of the motor switch. The better the motor switch is Leakage Circuit Breaker or No Fuse Breaker. It has a flip of the handle which can be pulled in the power “ON” or “OFF” control position.

When providing a multi-locking device of the invention, each lock part can be move linked to the action elements, respectively, to control the trip inside the locked unit of the motor switch. Then the handle of the motor switch cannot be pulled, unless all lock part are unlocked to let handle act.

Preferably, locking device of the present invention, the lock parts are respectively controlled by different keys, so can building a safe administrative control system. The lock can be different by different pieces of key storage-related units, such as a public safety unit, maintenance units, field construction units, or production units, if any one does not unlock the lock parts, the handle of the motor switch cannot be pulled.

Preferably, the invention, also comprising at least one limit switch for offer the signal to external side, and the limit switch is governed by the safety lock switch unit. For example, two limit switches, the first limit switch signal is to provide a central control system control with, the second limit switch signal is used to provide light. Of course, another option or parallel design approach, so that the safety lock unit itself also comprising a window for indicating whether the maintenance of equipment in the state, the direction of the window by the safety lock switch unit lines are move linked.

Handle of the motor switch can be pulled after it docked in a control position because the switch has a trip mechanism there within. The trip mechanism design approaches in accordance with the manufacturers have different design. But nothing more than the handle pulled after shifting, if the trip cannot be tripped escaping from institutions, the handle cannot automatically back to the power normal “OFF” position move by a major spring.

For example, the handle having an internal positioning plate move with the handle. A hook plate pivoted on the upper body of the trip. The hook plate has a brake-side, and a hook end for hook the positioning plate. And a small spring control the hook plate and let the hook plate can move to back to normal position.

When the positioning plate with the handle moves to reach a specific location, the hook end of the hook plate action, by the small spring, to hook the positioning plate, so that the handle cannot move. This time in general, the motor switch is in power “ON” control position. When the hook end of the positioning plate forced by external force, the hook plate will swing, it no longer hook positioning plate side effects, so that the handle being able to move by the major spring return in the power “OFF” control position.

As mentioned above, there are several forces which can swing hook plate for release the handle. The first is when the over-current, the copper wire by overheating of the switch internal displacement resulting from stretching to push the hook plate.

The second case is the pressure contact trip test unit's bar, to force the trip swing. The second scenario is to force open circuit, which is pulled handle, handle pulled by external force, push hook plate swinging first, so the hook side release the positioning plate. When the handle was caught out the positioning plate resistance, which is able to fast-moving and automatically return to original position by spring force. With safety lock unit, either by pushing, or pulling of the way, can prevent the handle move.

The invention of the motor switch locking devices can be improved with the following results. Through the safety lock power switch (Key-Lock) forced to lock the power switch (CB) not to move, so maintenance can prevent other people to restart the motor switch malfunction. In particular, the safety lock unit of the present invention, the different pieces of the key lock can be referred to the relevant powers and responsibilities of different units held separately, so it can effectively improve shirk the responsibility of the relevant units of each other. Innovative ideas of the present invention provides a simple safety lock unit, and used on a combination of the traditional motor switches without changing its structure. Based on the traditional motor switch can control the power system safety.

### BRIEF DESCRIPTION OF THE DRAWINGS

FIG. 1 is a top view shows the instrument of the preferred embodiment of this invention;

FIG. 2 is similes to FIG. 1, but shows another preferred embodiment and show the safety lock unit of this invention;

FIG. 3 is a plan view shows a action elements of the safety lock unit to press and limited the trip of motor switch wherein, so that handles cannot move; and

FIG. 4 is a side-view of the preferred embodiment of this invention shows the internal locking mechanism embodiment action.

FIG. 5 is similes to FIG. 3, but shows another preferred embodiment.

FIG. 6 is a perspective view shows the safety lock unit preferred embodiment of this invention combine with a mini circuit breaker.

### DETAILED DESCRIPTION OF THE PREFERRED EMBODIMENT

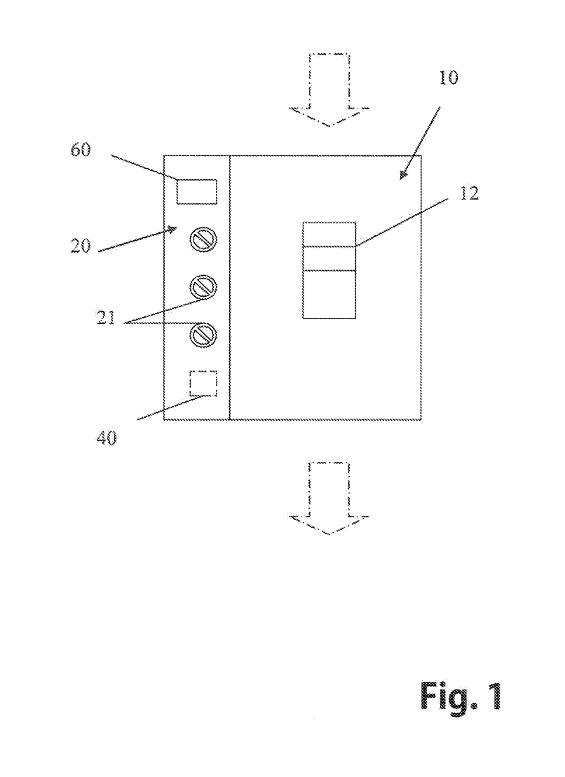

The invention of the motor switch locking devices, there are at least two kinds of preferred embodiments. The first shown as FIG. 1 is a combination of electrical motor switch with multiple types of locking devices. In other words, a motor switch having a safety locks thereon. The combination of types of these devices comprising a safety lock unit 20, and combined with the motor switch 10.

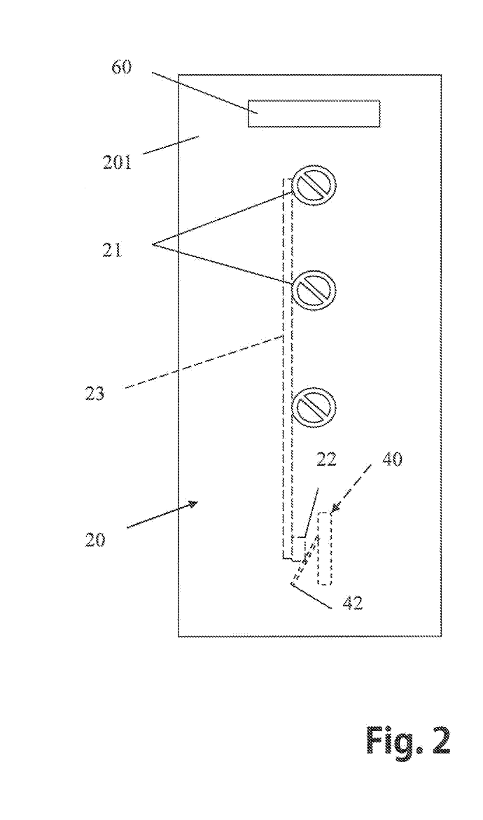

The second preferred embodiment is shown as FIG. 2, comprising only a safety lock unit 20 for fixed combination the motor switch to each other, or with the motor switch adjacent both to fixed in a substrate.

In any way, the motor switch 10 as shown in FIG. 1, with a set of internal over-current trip institutions, with a external handle 12 to control the main power. The safety lock switch unit 10 and motor 20 is fixed adjacent to each other.

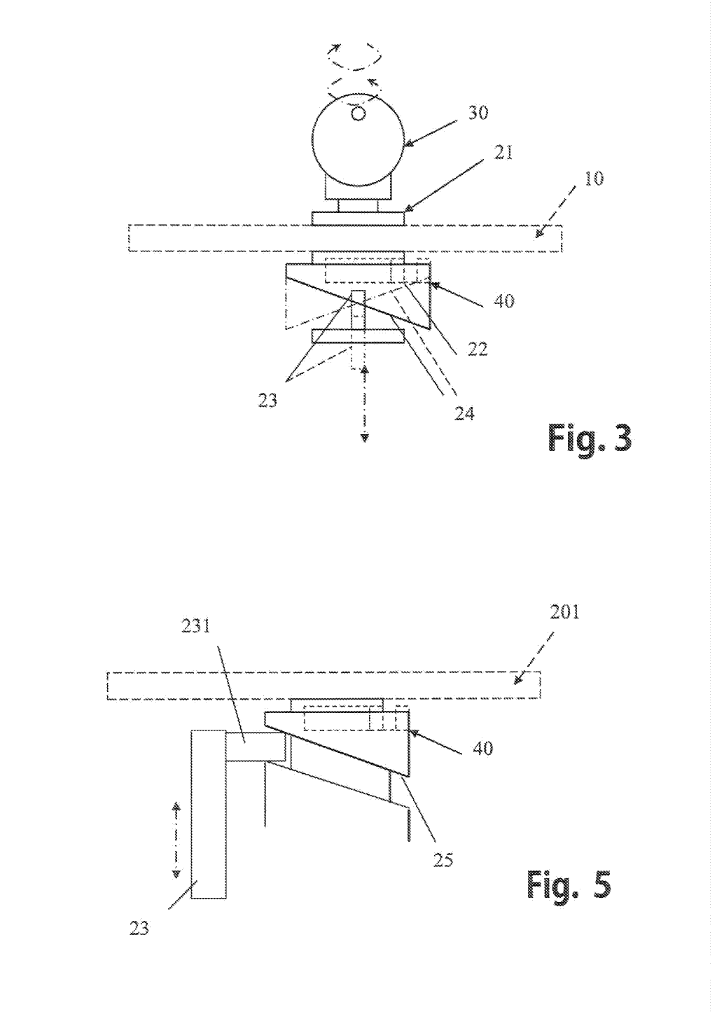

See FIGS. 1 to 3, the safety lock unit 20 preferred comprising a plurality of locking parts 21 which preferred is a safe power switch. Each one of the lock part 21 have related different keys 30 (see FIG. 3), and any one in a locked being able to control the handle 12 cannot action, while the power supply circuit turn off directly. When either a lock part 21 in a locked, can also be move linked an indicating unit 60 display the lock switch locked or not.

The locking devices of the invention is also preferred comprising a limit switch 40 (see FIGS. 1 and 2), for the external signal terminal. The limit switch 40 is moving linked by the active pieces 23 which drive by the any lock parts 21. And the lock parts 21 belong to the safety lock unit 20. See FIG. 3, the bottom of either a lock part 21 could move a small column 22. When the key 30 rotating the lock parts 21, the small column 22 can be indirectly touched a limit-chip 42 of the limit switch 40 as shown FIG. 2, so that the limit switch 40 or other equivalent device turned on or off signal terminal loop in the control of the proximal or distal end of display control situation. For example, is marked in the maintenance.

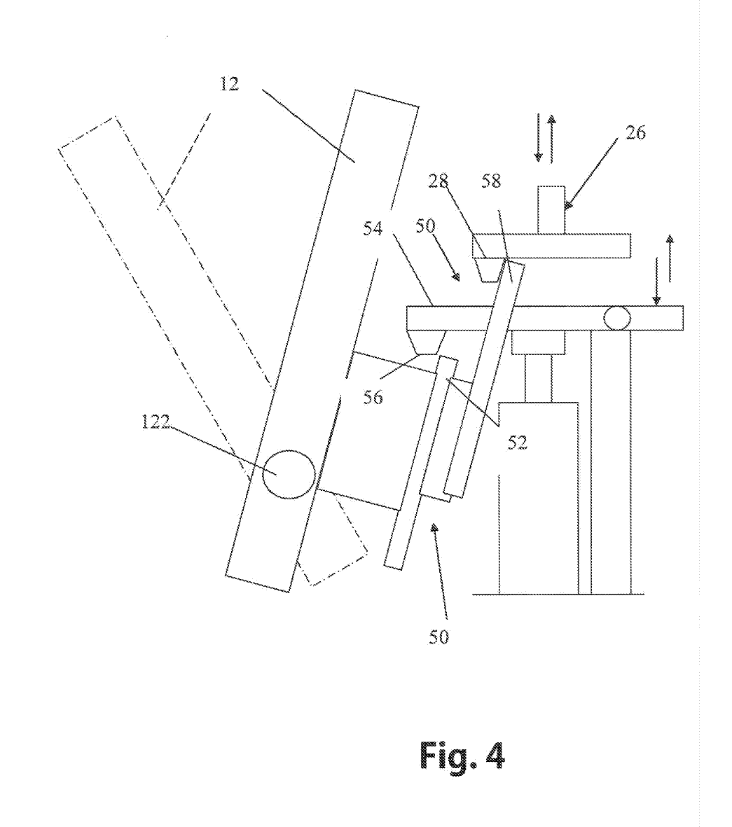

See FIG. 4, the motor switch 10 generally have a trip 50. Such as the details of art that are known to mature, the mechanism of the trip 50 has a major spring (not shown) for sliding the handle 12 after shifting position. Have many kinds of different designs for the trip mechanism 50. But anyway, even the handle 12 is pushed to the power “ON” position, once they are released by the trip 50, the handle 12 can automatically return to the main power “OFF” position by the major spring.

In FIG. 4, showing a positioning plate 52 internal links with handle 12 can move with the handle 12. The top on the trip 50 pivot located a hook plate 54. The hook plate 54 has a moving side effect with a hooked end 56 for hook a positioning plate 52. who is skill in the arts such as know, there is a small spring (not shown) controls the hook plate 54, so that the hook plate 54 able to back to normal position. When the handle 12 with the positioning plate 52 moves to reach a particular location, the hooked end 56 of the hook plate 54 able to hook the positioning plate 52 by the power of the small springs, and the handle 12 cannot move, this time to the general that the motor switch is in the power “ON”.

When the moving side of the brake plate 54 forced by external force, the hook plate 54 will swing, the hooked end 56 no longer caught the positioning side 52, so the handle 12 being able to move back to the position by the major spring force, the generally the motor switch is in the power “OFF”.

Any one action element of the lock parts 21 belong to the lock unit 20 can limit respectively the motor switch 10 so that the handle 12 cannot act, so that the motor switch 10 can control the main power supply circuit.

Although FIG. 4 shows the lock pieces 21 to drive the convex rod 28, or to drive the active pieces 23 linked with the convex rod 28, is pressure decreased by slope 24 to produce displacement. However, as shown in FIG. 5, the spiral groove 25 can also be made in the bottom of the lock piece 21. And in other hand, be made an end flange 231 on the moving part 23 for set into the groove 25, so the moving part 23 can act. However, the force translate from lock piece 21 which whether it is pushing, or pulling, are the creative ideas range of this invention.

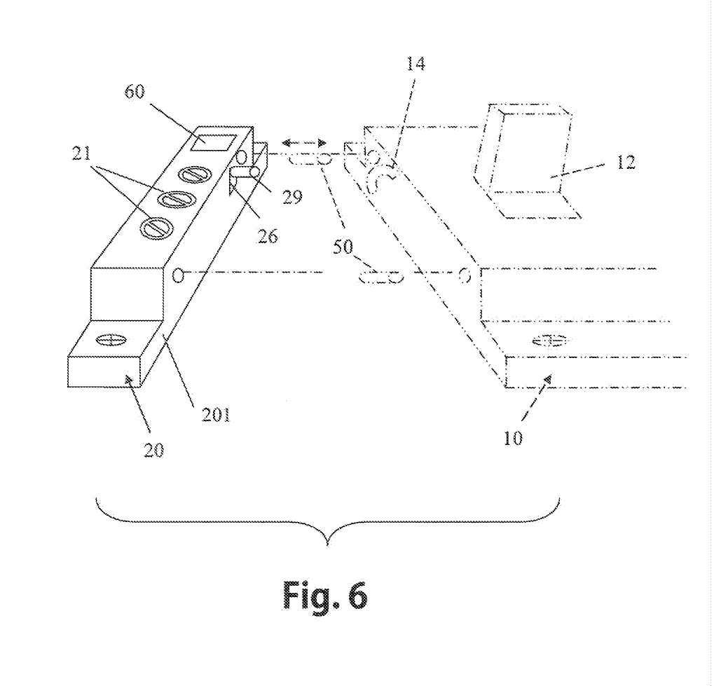

In FIG. 6, which shows the safety lock unit 20 combined with the motor switch 10 that is called “mini circuit breaker”. The motor switch has a side hole 14. And there is a moving part inside the motor switch 10. When the handle 12 pull or push, the moving part able to move up or down follow with the handle 12. The safety lock unit 20 having a body 201 for combined to the motor switch 10; at least one lock part 21; and a convex rod 29 linked to the lock part 21.

In other hand, the body 20 is having a long hole 26 on the side forward to motor switch 1, and a movable convex rod 28 be exposed through the long hole 26 Align the side hole 14 of the motor switch 1. When the lock piece 21 Locked, the convex rod 28 may be stuck moving parts inside the motor switch 1, so that the handle 12 of the motor switch 1 cannot be pulled free. The box body 20 and the motor switch 1 be combined together each other by the link element 50, for example screws or spring pins.

Although actual and practical experiences from this invention have proven that the design is feasible, but as it is well known to all, there is no restriction on design of this aiming device. Anyone possessing relevant knowledge of such technique is allowed to make slight modification or further improvements, nonetheless, it should not be carried out if the nature of the subject is neglected, and should still be within the scope of the appended claims.

What is claimed:

1. A motor switch locking devices having a safety lock unit for the motor switch adjacent to the fixed, said safety lock unit comprising at least a lock parts, and a action element move linked the lock part; the action element have a control element extended from the motor switch to control a trip-locked unit inside the motor switch.

2. A motor switch locking devices according to the claim 1, said safety lock unit is a safety lock source switch.

3. A motor switch locking devices according to the claim 1, said lock parts are controlled by different keys.

4. A motor switch locking devices according to the claim 1, said safety lock unit further comprising a window unit for indicating whether the maintenance of equipment in the state, and the direction of the window is controlled by said safety lock unit.

5. A motor switch locking devices, comprising a safety lock unit for the motor switch adjacent to the fixed, the safety lock unit has a plurality of lock parts, and a action element act-linked by each said lock part; said action element have a control end extended said motor switch; each said lock parts can be act said action element respectively, so that said control end of said action element to limit said motor switch turn off, unless the plurality of lock unlock all parts.

6. A motor switch locking devices according to the claim 5, said safety lock unit is a safety lock source switch.

7. A motor switch locking devices according to the claim 5, said lock parts are controlled by different keys.

8. A motor switch locking devices according to the claim 5, said safety lock unit further comprising a window unit for indicating whether the maintenance of equipment in the state, and the direction of the window is controlled by said safety lock unit.

9. A motor switch locking devices according to the claim 5, said locking devices is for the motor switch adjacent combination.

10. A motor switch with a locking devices assembly comprising:
a motor switch, said motor switch has a over-current trip located inside; a trip lockout unit; and a handle located in the exterior of said motor switch to control the main power circuit; and
a safety lock unit which combination adjacent to said motor switch to each other;
said safety lock unit has a plurality of lock parts, with a lock parts linked by the action elements; and
said safety lock unit has a plurality of lock parts, and a action element act-linked by each said lock part; said action element have a control end extended said motor switch; each said lock parts can be act said action element respectively, so that said control end of said action element to limit said motor switch turn off, unless the plurality of lock unlock all parts.

11. A motor switch with a locking devices assembly according to the claim 9, said motor switch is no fuse switch.

12. A motor switch with a locking devices assembly according to the claim 9, said motor switch is leakage circuit breaker.

13. A motor switch with a locking devices assembly according to the claim 9, said motor switch is mini circuit breaker.

14. A motor switch with a locking devices assembly according to the claim 9, said safety lock unit is a safety lock source switch.

15. A motor switch with a locking devices assembly according to the claim 9, said lock parts is controlled by different keys.

16. A motor switch with a locking devices assembly according to the claim 9, further comprising at least a limit switch is controlled by said safety lock unit for electric-connected to an exterior signal unit.

17. A motor switch with a locking devices assembly according to the claim 9, further comprising a window unit for indicating whether the maintenance of equipment in the state, and the direction of the window is controlled by said safety lock unit.

18. A motor switch with a locking devices assembly according to the claim 9 comprising the first limit switch and the second limit switch, said first limit switch signal is to provide a central control system control with, and said second limit switch signal is used to indicate light of the scene.
